(19) United States
(12) Patent Application Publication
(10) Pub. No.: US 2021/0044009 A1
(43) Pub. Date: Feb. 11, 2021

(54) PLANAR ANTENNA

(71) Applicant: Shenzhen Antop Technology Co. Ltd., Shenzhen (CN)

(72) Inventors: Ruidian YANG, Shenzhen (CN); Boliang YANG, Shenzhen (CN)

(21) Appl. No.: 16/731,636

(22) Filed: Dec. 31, 2019

(30) Foreign Application Priority Data
Aug. 6, 2019 (CN) 201921275968.X

(51) Int. Cl. H01Q 1/44; H01Q 1/00; H01Q 1/12; A47G 1/16; A47G 1/06

(52) U.S. Cl. CPC H01Q 1/44; H01Q 1/007; A47G 1/0633; A47G 1/1653; H01Q 1/1214

(57) ABSTRACT

The invention discloses a planar antenna including an antenna body and fasteners for fixing a picture or photo. The antenna body has a first surface and a second surface that are opposite to each other, and the fasteners are provided on the first surface and/or the second surface. A user can fix the picture or photo to the antenna body through the fasteners, so that the planar antenna can become a photo frame or a display board, which enables the antenna to become part of indoor design for decorating interior space.

### TECHNICAL FIELD

The invention relates to the technical field of antennas, in particular to a planar antenna.

### BACKGROUND ART

An antenna is a component used in a radio to transmit or receive electromagnetic waves. Any engineering system using electromagnetic waves to convey information, such as radio communication, broadcasting, television, radar, navigation, electronic countermeasure, remote sensing, radio astronomy and the like, needs to work by means of the antenna. With the popularity of wireless digital television signals, more and more people install antennas indoors to receive television signals. For signal reception, the antenna is generally required to be installed at locations that can cover most indoor places, and these locations are often highly visible, so that the installation of the antenna usually affects the effect of indoor design to a certain extent. With the development of antenna technology, people begin to install planar antennas in interior space inside a room or a car, which can solve the problem of occupying the interior space by the antennas to some degree and reduce impact on interior space design. However, it is still quite difficult to match the style of the interior space design.

### SUMMARY

In view of this, the present invention provides a planar antenna with a decorative effect that can match the style of interior space design in order to overcome at least one of the deficiencies described in the above prior art.

In order to solve the above technical problems, the invention adopts the following technical solutions.

A planar antenna includes an antenna body and fasteners for fixing a picture or photo. The antenna body has a first surface and a second surface that are opposite to each other, and the fasteners are provided on the first surface and/or the second surface. A user can fix the picture or photo to the antenna body through the fasteners, so that the planar antenna can become a photo frame or a display board, which not only reduces the existence of the antenna, but also enables the antenna to become part of indoor design for decorating interior space.

One solution is that the fasteners include a transparent film laid on the first surface and/or the second surface. The user can put the whole picture or photo in the transparent film, so that dust and the like can be prevented from falling on the picture or photo which is better protected. A part of the picture or photo can also be placed in the transparent film.

The transparent film is in a single-layer film structure, and an edge of the transparent film is fixedly connected to the antenna body. A receiving space for containing the picture or photo is formed between the transparent film and the first surface or the second surface. At least one edge among an upper edge or a left edge or a right edge of the transparent film is separated from the first surface or the second surface to form an opening of the receiving space. Preferably, the edge of the transparent film forming the opening is provided with a notch for conveniently taking out the picture or photo, so that the user can easily take out the picture or photo placed therein. Preferably, both the left edge and the right edge of the transparent film are separated from the first surface or the second surface to form the opening. Another picture or photo can be used to be inserted from the left edge to push out the picture or photo originally placed in the receiving space from the right edge, or can be inserted from the right edge to push out the picture or photo originally placed in the receiving space from the left edge.

The transparent film is in the single-layer film structure, and the edge of the transparent film is fixedly connected to the antenna body. The receiving space for containing the picture or photo is formed between the transparent film and the first surface or the second surface. The opening of the receiving space is defined on the surface of the transparent film.

The edge of the transparent film is fixed to the first surface and/or the second surface by a high-frequency voltage. The antenna body includes two plates located on the front and rear and an element sandwiched between the two plates. When providing the transparent film, the transparent film can be fixed to an outer surface of one plate by a voltage before placing the element on an inner surface thereof and bonding the element with the other plate using printing glue. The transparent film can also be fixed to a finished antenna body by the voltage.

Another solution is that the fasteners include at least two connecting parts fixedly connected with the antenna body and a clamping part located between the two adjacent connecting parts, and a clamping space is formed between the clamping part and the first surface or the second surface for clamping the picture or photo. The two adjacent connecting parts can be provided at a distance, and the clamping part is formed between the two adjacent connecting parts. The two adjacent connecting parts can also be provided at an angle, and the clamping part is formed in an included angle between the two adjacent connecting parts. Preferably, the clamping part is made of a transparent material. The connecting parts of the fasteners are fixed to the first surface and/or the second surface by the high-frequency voltage.

Compared with the prior art, beneficial effects of the present invention are as follows. The fasteners are provided on the surface of the planar antenna, so that the user can place the picture or photo in the fasteners to enable the planar antenna to become the photo frame or the display board, which not only reduces the existence of the antenna, but also enables the antenna to become part of the indoor design for decorating interior space. The fasteners can be fixed on the first surface and/or the second surface by using the high-frequency voltage, and the process is simple. The fasteners are simple in structure and light in weight, and do not have a great impact on the weight of a finished planar antenna and the impact can almost be ignored. In addition, the thickness of the fasteners is negligibly small so as to facilitate storage and transportation without occupying space.

### BRIEF DESCRIPTION OF THE DRAWINGS

FIG. 1 is a first schematic diagram of a planar antenna in a using state in Embodiment 1.

FIG. 2 is a second schematic diagram of the planar antenna in the using state in Embodiment 1.

FIG. 3 is a third schematic diagram of the planar antenna in the using state in Embodiment 1.

FIG. 4 is a schematic diagram of a planar antenna in a using state in Embodiment 2.

FIG. 5 is a schematic diagram of a planar antenna in a using state in Embodiment 3.

FIG. 6 is a first schematic diagram of a planar antenna in a using state in Embodiment 4.

FIG. 7 is a second schematic diagram of the planar antenna in the using state in Embodiment 4.

FIG. 8 is a third schematic diagram of the planar antenna in the using state in Embodiment 4.

FIG. 9 is a fourth schematic diagram of the planar antenna in the using state in Embodiment 4.

### DESCRIPTION OF EMBODIMENTS

The drawings of the invention are for illustrative purposes only and are not to be construed as limiting the present invention. In order to better illustrate the following embodiments, certain components of the drawings may be omitted, enlarged, or reduced, and do not represent the dimensions of the actual product. It will be understood that some known structures and descriptions thereof in the drawings may be omitted for those skilled in the art. The description of positional relationship in the drawings is for illustrative purpose only and is not intended to limit the present invention. The present invention will be further described in detail below with reference to specific embodiments.

### Embodiment 1

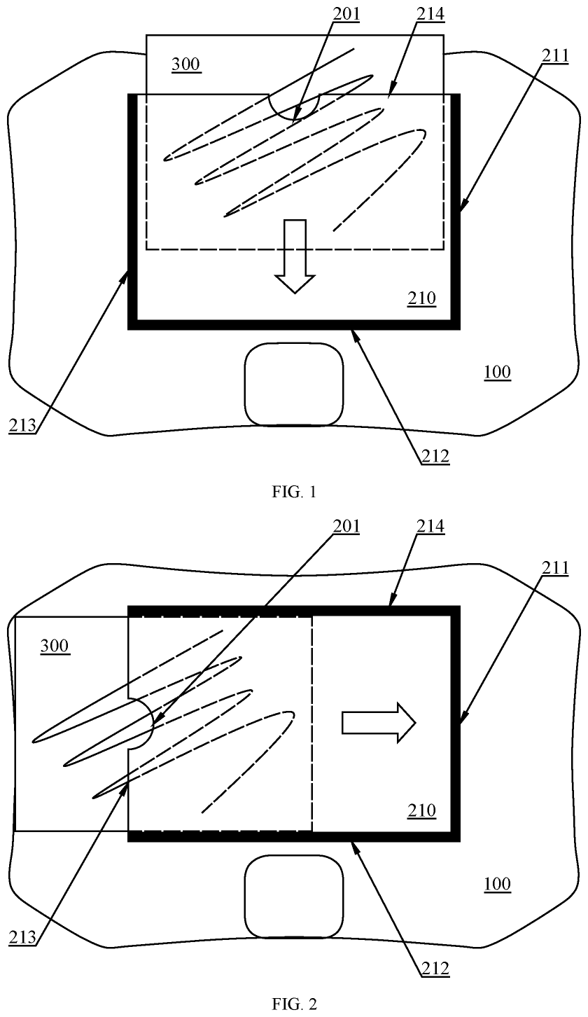

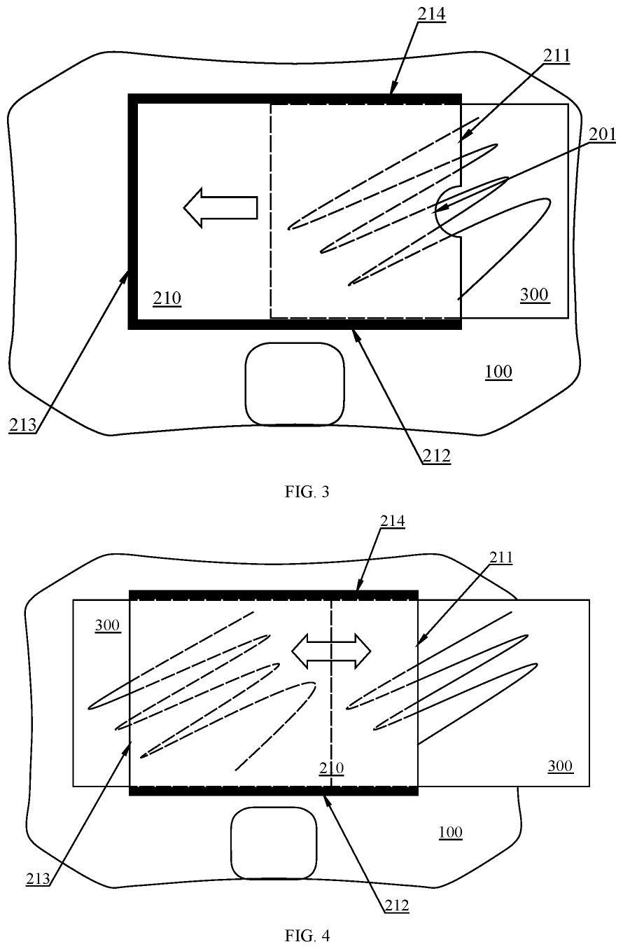

As shown in FIGS. 1 to 3, a planar antenna includes an antenna body 100 and fasteners for fixing a picture or photo 300. The antenna body 100 has a first surface and a second surface that are opposite to each other, and the fasteners are provided on the first surface and/or the second surface. A user can fix the picture or photo 300 to the antenna body 100 through the fasteners, so that the planar antenna can become a photo frame or a display board, which not only reduces the existence of the antenna, but also enables the antenna to become part of indoor design for decorating interior space.

The fasteners include a transparent film 210 laid on the first surface and/or the second surface. The user can put the whole picture or photo 300 in the transparent film 210, so that dust and the like can be prevented from falling on the picture or photo 300 which is better protected. A part of the picture or photo 300 can also be placed in the transparent film 210.

The transparent film 210 is in a single-layer film structure, and an edge of the transparent film 210 is fixedly connected to the antenna body 100. A receiving space for containing the picture or photo 300 is formed between the transparent film 210 and the first surface or the second surface. At least one edge among an upper edge 214 or a left edge 213 or a right edge 211 of the transparent film 210 is separated from the first surface or the second surface to form an opening of the receiving space. The edge of the transparent film 210 forming the opening is provided with a notch 201 for conveniently taking out the picture or photo 300, so that the user can easily take out the picture or photo placed therein.

The edge of the transparent film 210 is fixed to the first surface and/or the second surface by a high-frequency voltage. The antenna body 100 includes two plates located on the front and rear and an element sandwiched between the two plates. When providing the transparent film, the transparent film can be fixed to an outer surface of one plate by a voltage before placing the element on an inner surface thereof and bonding the element with the other plate using printing glue. The transparent film can also be fixed to a finished antenna body 100 by the voltage.

### Embodiment 2

As shown in FIG. 4, a planar antenna includes an antenna body 100 and fasteners for fixing a picture or photo 300. The antenna body 100 has a first surface and a second surface that are opposite to each other, and the fasteners are provided on the first surface and/or the second surface. A user can fix the picture or photo 300 to the antenna body 100 through the fasteners, so that the planar antenna can become a photo frame or a display board, which not only reduces the existence of the antenna, but also enables the antenna to become part of indoor design for decorating interior space.

The fasteners include a transparent film 210 laid on the first surface and/or the second surface. The user can put the whole picture or photo 300 in the transparent film 210, so that dust and the like can be prevented from falling on the picture or photo 300 which is better protected. A part of the picture or photo 300 can also be placed in the transparent film 210.

The transparent film 210 is in a single-layer film structure, and an edge of the transparent film 210 is fixedly connected to the antenna body 100. A receiving space for containing the picture or photo 300 is formed between the transparent film 210 and the first surface or the second surface. Both a left edge 213 and a right edge 211 of the transparent film 210 are separated from the first surface or the second surface to form an opening. Another picture or photo 300 can be used to be inserted from the left edge 213 to push out the picture or photo 300 originally placed in the receiving space from the right edge 211, or can be inserted from the right edge 211 to push out the picture or photo 300 originally placed in the receiving space from the left edge 213.

An upper edge 214 and a lower edge 212 of the transparent film 210 are fixed to the first surface and/or the second surface by a high-frequency voltage. The antenna body 100 includes two plates located on the front and rear and an element sandwiched between the two plates. When providing the transparent film, the transparent film can be fixed to an outer surface of one plate by a voltage before placing the element on an inner surface thereof and bonding the element with the other plate using printing glue. The transparent film can also be fixed to a finished antenna body 100 by the voltage.

### Embodiment 3

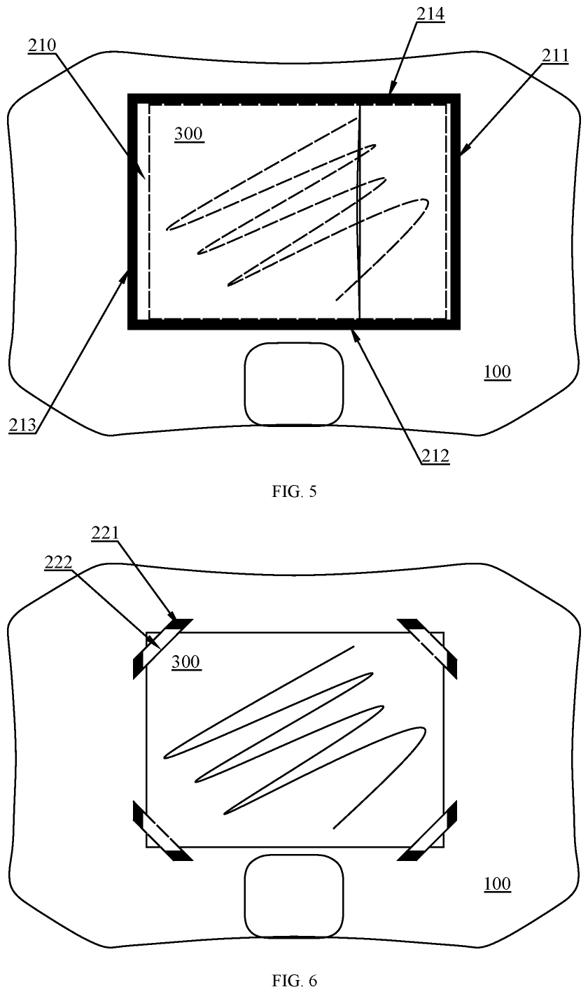

As shown in FIG. 5, a planar antenna includes an antenna body 100 and fasteners for fixing a picture or photo 300. The antenna body 100 has a first surface and a second surface that are opposite to each other, and the fasteners are provided on the first surface and/or the second surface. A user can fix the picture or photo 300 to the antenna body 100 through the fasteners, so that the planar antenna can become a photo frame or a display board, which not only reduces the existence of the antenna, but also enables the antenna to become part of indoor design for decorating interior space.

The fasteners include a transparent film 210 laid on the first surface and/or the second surface. The user can put the whole picture or photo 300 in the transparent film 210, so that dust and the like can be prevented from falling on the picture or photo 300 which is better protected. A part of the picture or photo 300 can also be placed in the transparent film 210.

The transparent film 210 is in a single-layer film structure, and the edge of the transparent film 210 is fixedly connected to the antenna body 100. A receiving space for containing the picture or photo 300 is formed between the transparent film 210 and the first surface or the second surface. An opening of the receiving space is defined on the surface of the transparent film 210.

The edge of the transparent film 210 is fixed to the first surface and/or the second surface by a high-frequency machine voltage. The antenna body 100 includes two plates located on the front and rear and an element sandwiched between the two plates. When providing the transparent film, the transparent film can be fixed to an outer surface of one plate by a voltage before placing the element on an inner surface thereof and bonding the element with the other plate using printing glue. The transparent film can also be fixed to a finished antenna body 100 by the voltage.

### Embodiment 4

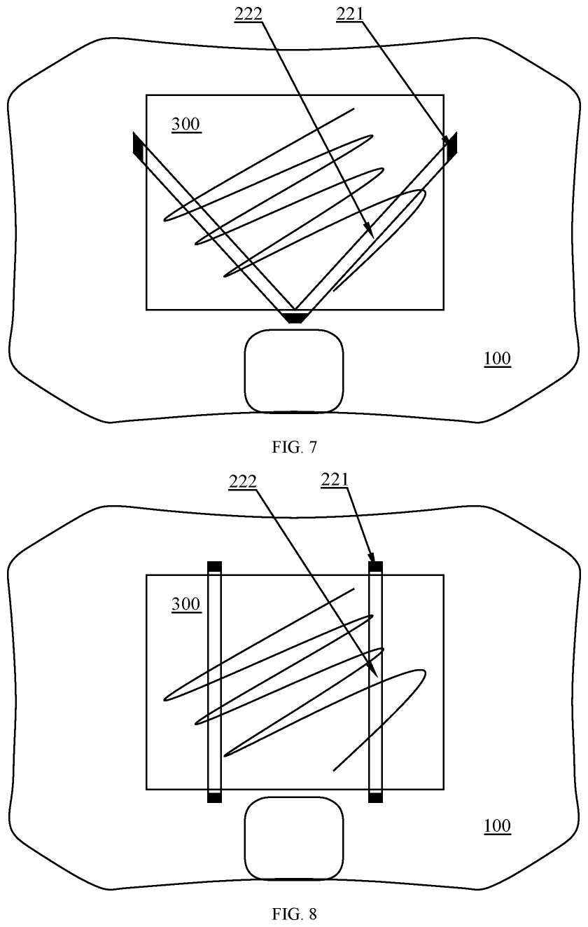

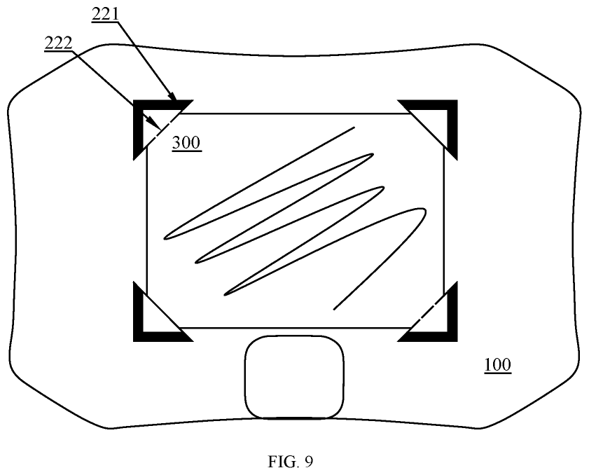

As shown in FIGS. 6 to 9, a planar antenna includes an antenna body 100 and fasteners for fixing a picture or photo 300. The antenna body 100 has a first surface and a second surface that are opposite to each other, and the fasteners are provided on the first surface and/or the second surface. A user can fix the picture or photo 300 to the antenna body 100 through the fasteners, so that the planar antenna can become a photo frame or a display board, which not only reduces the existence of the antenna, but also enables the antenna to become part of indoor design for decorating interior space.

The fasteners include at least two connecting parts 221 fixedly connected with the antenna body 100 and a clamping part 222 located between the two adjacent connecting parts 221, and a clamping space is formed between the clamping part 222 and the first surface or the second surface for clamping the picture or photo 300. The two adjacent connecting parts 221 can be provided at a distance, and the clamping part 222 is formed between the two adjacent connecting parts 221. The two adjacent connecting parts 221 can also be provided at an angle, and the clamping part 222 is formed in an included angle between the two adjacent connecting parts 221. Preferably, the clamping part 222 is made of a transparent material. The connecting parts 221 of the fasteners are fixed to the first surface and/or the second surface by a high-frequency machine voltage.

Obviously, the above embodiments of the present invention are merely examples for clear illustration of the invention, and are not intended to limit the implementation of the invention. For those skilled in the art, modifications or changes in other forms can also be made on the basis of the above description. It is unnecessary and impossible to exhaust all implementations herein. Any modification, equivalent substitution or improvement and the like within the spirit and principle of the present invention should be included in the scope of claims of the present invention.

1. A planar antenna, comprising an antenna body and a fastener for fixing a picture or photo, wherein the antenna body has a first surface and a second surface that are opposite to each other, and the fastener is provided on the first surface and/or the second surface.

2. The planar antenna according to claim 1, wherein the fastener includes a transparent film laid on the first surface and/or the second surface.

3. The planar antenna according to claim 2, wherein the transparent film is in a single-layer film structure, an edge of the transparent film is fixedly connected to the antenna body, a receiving space for containing the picture or photo is formed between the transparent film and the first surface or the second surface, and an opening of the receiving space is formed by that at least one edge among an upper edge or an left edge or an right edge of the transparent film is separated from the first surface or the second surface.

4. The planar antenna according to claim 3, wherein the edge of the transparent film forming the opening is provided with a notch for conveniently taking out the picture or photo.

5. The planar antenna according to claim 3, wherein the opening of the receiving space is formed by that both the left edge and the right edge of the transparent film are separated from the first surface or the second surface.

6. The planar antenna according to claim 2, wherein the transparent film is in a single-layer film structure, an edge of the transparent film is fixedly connected to the antenna body, a receiving space for containing the picture or photo is formed between the transparent film and the first surface or the second surface, and an opening of the receiving space is arranged on the surface of the transparent film.

7. The planar antenna according to claim 2, wherein the edge of the transparent film is fixed to the first surface and/or the second surface by a high-frequency voltage.

8. The planar antenna according to claim 1, wherein the fastener includes at least two connecting parts fixedly connected with the antenna body and a clamping part located between the two adjacent connecting parts, and a clamping space is formed between the clamping part and the first surface or the second surface for clamping the picture or photo.

9. The planar antenna according to claim 8, wherein the clamping part is made of a transparent material.

10. The planar antenna according to claim 8, wherein the connecting parts of the fastener are fixed to the first surface and/or the second surface by a high cycle wave voltage.
